(19) United States
(12) Patent Application Publication
(10) Pub. No.: US 2015/0226240 A1
(43) Pub. Date: Aug. 13, 2015

(54) FLUID ISOLATOR

(71) Applicant: Hydraulic Isolator & Safety Technology Pty Limited, Muswellbrook (AU)

(72) Inventors: Anthony Kropp, Muswellbrook (AU); Dwayne Minch, Muswellbrook (AU)

(21) Appl. No.: 14/424,728

(22) PCT Filed: Aug. 26, 2013
(86) PCT No.: PCT/AU2013/000949

§ 371 Date: Feb. 27, 2015

(30) Foreign Application Priority Data
Aug. 27, 2012 (AU) 2012903684

(51) Int. Cl. F15B 20/00; E02F 9/22; F15B 21/00

(52) U.S. Cl. CPC F15B 20/00; F15B 21/005; E02F 9/226

(57) ABSTRACT

A fluid isolator includes a primary outlet port adapted-to be coupled to a hydraulic device; a bleed valve having a first and a second position; a first line in fluid communication with the primary outlet port and the bleed valve; a first and second one way valve located in the first line inhibiting the flow of fluid toward the primary outlet port; a primary gauge port adapted to be coupled with a pressure gauge; and a second line in fluid communication with the primary gauge port and a portion of the first line located between the first and the second one way valve; wherein the bleed valve is switchable between the first and second position to permit the flow of fluid from the primary outlet port to a region of lower fluid pressure.

### FIELD OF THE INVENTION

The present invention relates to a fluid isolator. In particular, the present invention relates to a hydraulic isolator for depressurising hydraulic circuits. However, it will be appreciated that the fluid isolator may be used with pneumatic circuits and other applications.

### BACKGROUND OF THE INVENTION

Hydraulic systems provide power transfer and movement in equipment used in various technology areas, such as machinery used in mining, construction and agriculture.

It is necessary to de-pressurise a hydraulic line or circuit at certain times, for example when a hydraulic hose needs to be disconnected during maintenance or servicing. The de-pressurisation process is essential to reduce the risk of injury to personnel by high pressure fluid. However, despite workers being generally aware of the issues and prevailing risks, accidents still occur with hydraulic fluid. One problem that arises relates to the residual pressure in a hydraulic line which may still be dangerously high after an attempted de-pressurisation has been conducted.

Secondly, technicians sometimes mistakenly assume that a line has low or no pressure, when in fact it is still under high pressure.

Hydraulic couplings historically utilised male and female threaded fasteners. Accordingly, when a technician believed a hydraulic line to have been safely depressurised, by slowly unscrewing the thread, the hydraulic fluid would leak immediately after the seal was broken, indicating to the technician if the line still contained high pressure fluid.

However, a recent trend in hydraulic equipment is that lines are increasingly being coupled together with snap lock type fittings. Whilst snap lock fittings are fast to connect and disconnect, they provide the disadvantage of being very dangerous if they are disconnected while the line pressure is still too high. Because the snap lock fitting is fast to disconnect, there are incidents of personnel being injured and killed by the hose whipping around, and either striking a person, or spraying the person with hydraulic fluid which may be at very high pressures, and temperatures.

In the event of a fire occurring on or near a hydraulically operated machine, there is a risk of the fire burning through one or more hydraulic lines. This can cause several significant problems, such as the rapid de-pressurisation of the hydraulic circuit resulting in machinery such as booms or other raised or pressurised components falling quickly to the ground. In addition, most hydraulic fluids are mineral oil based, and hence flammable, which adds to the intensity and danger of such fires occurring around hydraulic machinery.

### OBJECT OF THE INVENTION

It is an object of the present invention to substantially overcome or at least ameliorate one or more of the above disadvantages, or at least to provide a useful alternative.

### SUMMARY OF THE INVENTION

In a first aspect, the present invention provides a fluid isolator comprising:
a primary outlet port adapted to be coupled to a hydraulic device;
a bleed valve having a first position and a second position;
a first line in fluid communication with the primary outlet port and the bleed valve;
a first one way valve located in the first line, the first one way valve inhibiting the flow of fluid toward the primary outlet port;
a second one way valve located in the first line, the second one way valve inhibiting the flow of fluid toward the primary outlet port;
a primary gauge port adapted to be coupled with a pressure gauge; and
a second line in fluid communication with the primary gauge port and a portion of the first line located between the first one way valve and the second one way valve;
wherein the bleed valve is switchable between the first position and the second position to permit the flow of fluid from the primary outlet port to a region of lower fluid pressure.

The fluid isolator further preferably comprising one or more secondary outlet ports, each secondary outlet port being adapted to be coupled to an additional hydraulic device,
a third line extending between each secondary outlet port and the first line between the second one way valve and the bleed valve;
a third one way valve located in the third line, the third one way valve inhibiting the flow of fluid toward the secondary outlet port;
a fourth one way valve located in the third line, the fourth one way valve inhibiting the flow of fluid toward the secondary outlet port;
an secondary gauge port adapted to be coupled with a pressure gauge; and
a fourth line in fluid communication with the secondary gauge port and a portion of the third line located between the third one way valve and the fourth one way valve.

A first test port is preferably located in the first line between the second one way valve and the bleed valve.

A second test port is preferably located in the first line between the second one way valve and the bleed valve.

The primary and secondary gauge ports are preferably double check valves.

The bleed valve is preferably a direction control valve. In particular, the bleed valve is preferably a four port two position direction control valve.

The bleed valve is preferably manually operable. Alternatively the bleed valve may include a solenoid and is electrically operable.

The fluid isolator preferably comprises a manual control to selectively provide fluid communication with the primary gauge port and the secondary gauge port.

The manual control is preferably a button, knob or lever.

In a second aspect, the present invention provides a hydraulic system comprising:
a fluid isolator as described above;
a fluid reservoir in fluid communication with the bleed valve;
a pump in fluid communication with the fluid reservoir;
a control valve in fluid communication with the pump;
an accumulator in fluid communication with the control valve and one of the primary or secondary outlet ports of the fluid isolator;
a hydraulic device in fluid communication with the control valve; and
a line extending between one of said primary or secondary outlet ports of the fluid isolator and a line extending between the control valve and the hydraulic device.

### BRIEF DESCRIPTION OF THE DRAWINGS

A preferred embodiment of the invention will now be described by way of specific example with reference to the accompanying drawings, in which:

FIG. 1 depicts a hydraulic circuit according to the invention;

FIG. 2 is a front view of a hydraulic isolator according to an embodiment of the invention;

FIG. 3 is a top view of the hydraulic isolator of FIG. 2;

FIG. 4 is a rear view of the hydraulic isolator of FIG. 2; and

FIG. 5 is a schematic view of a hydraulic system including the isolator of FIG. 1.

### DETAILED DESCRIPTION OF THE PREFERRED EMBODIMENTS

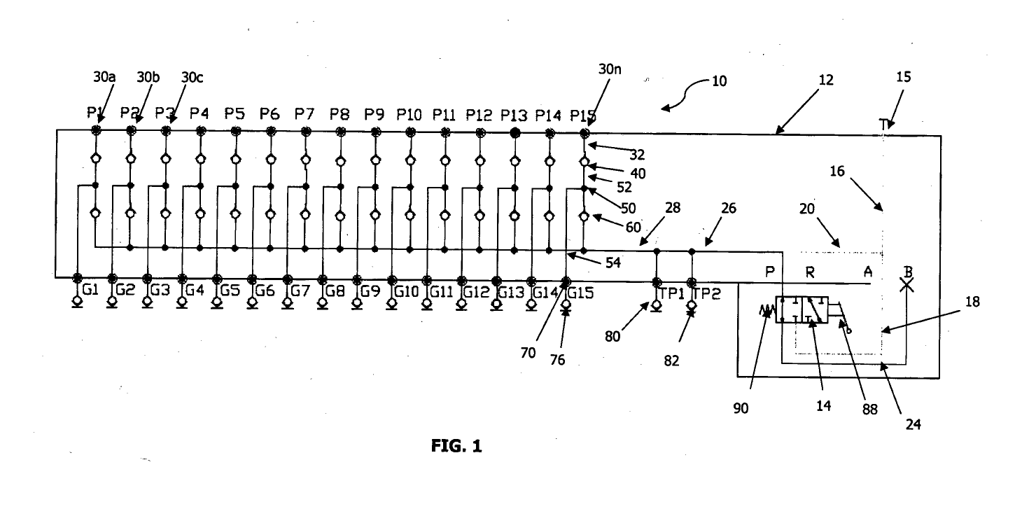

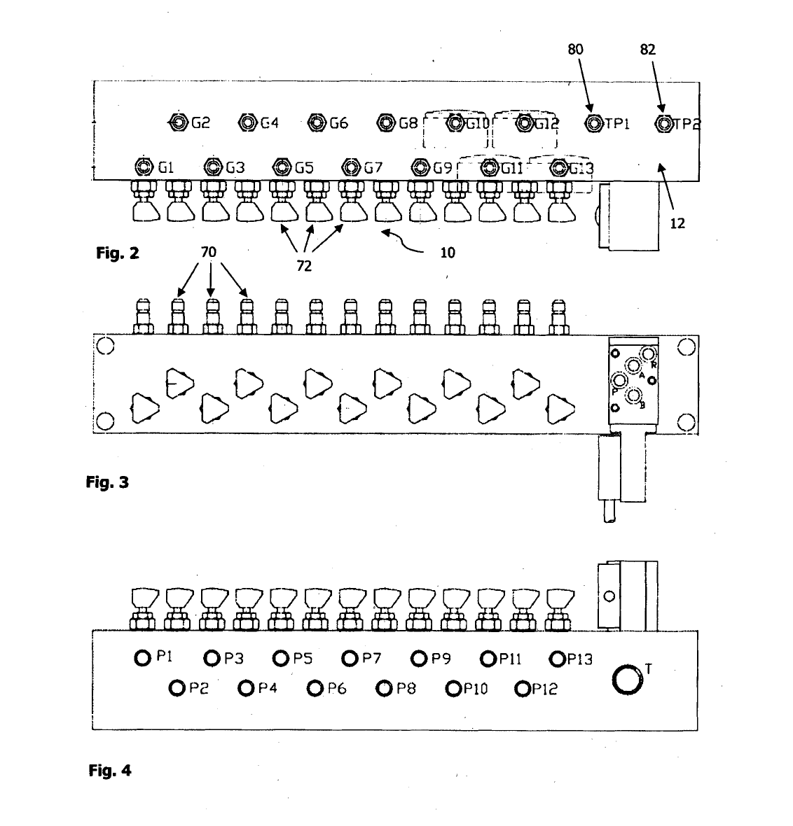

A fluid isolator 10 for use in hydraulic or pneumatic systems is disclosed in FIG. 1. The isolator 10 is housed in a manifold 12 which is depicted in FIGS. 2 to 4. The manifold 12 is configured to provide the required number of hydraulic outputs for a given hydraulic application. The number of outputs is typically between 4 and 20, although other amounts are possible.

The isolator 10 includes a bleed valve 14 in the form of a direction control valve 14. The valve 14 is typically a four port two position valve 14, although other suitable valves may be utilised. The direction control valve 14 may be controlled manually or by an electrically operated solenoid. As depicted in FIG. 1, a hydraulic line 16 is in fluid communication with a hydraulic tank or reservoir 15. The line 16 branches into two hydraulic lines 18, 20. In the first and second positions of the vale 14, there is no flow of hydraulic fluid across the direction control valve 14 between lines 18 and 20. In some embodiments, the line 20 may not be included.

Another hydraulic line 24 is in fluid communication with the direction control valve 14. This line 24 terminates at the housing of the manifold 12 with a port which is labelled “B” on the manifold 12. A further hydraulic line 26 is also in fluid communication with the direction control valve 14. Line 24 may be blocked at “B” to prevent the flow if fluid when the isolator is in the valve 14 position depicted in FIG. 1.

In the direction control valve 14 position depicted in FIG. 1, there is fluid flow across the valve 14 between lines 24 and 26, however as described above, line 24 does not provide a fluid flow path.

In the alternative switch position (not shown) there is no fluid flow across the valve 14 between lines 24 and 26. In contrast, in the alternative switch position (corresponding to a hydraulic fluid depressurisation or dump) line 26 is connected to the tank 15 through lines 18 and 16.

The isolator 10 includes at least one outlet port 30. However, in the embodiment shown in FIG. 1, there is an array of fifteen outlet ports 30. Each outlet port 30 corresponds to a given hydraulic motor, cylinder or other such hydraulically operated component on hydraulic machine. For example, on an excavator, output 30a may be used to energise a first side of a first double acting cylinder to tilt the bucket. Output 30b in contrast may be used to energise the opposing side of the first double acting cylinder. In contrast output 30c may be used to extend a boom of the excavator, to raise the bucket. As such, the isolator 10 is provided with a sufficient number of outlet ports 30 to correspond with the number of hydraulic devices on a given hydraulic machine.

Each outlet port 30 is connected to a respective hydraulic line 32. A first one way check valve 40 is provided in each line 32. The first one way check valves 40 permits the hydraulic fluid to flow from the outlet port 30 into an isolated oil gallery 50. In addition, the first one way check valve 40 prevents the hydraulic fluid from back flowing from the isolated oil gallery 50 to the outlet port 30.

Each isolated oil gallery 50 includes a first line 52 extending between the first one way check valve 40 and a second one way check valve 60. The isolated oil gallery 50 also includes another line 54 which branches off the first line 52, and is in fluid communication with a gauge port 70. As such, there is a gauge port 70 corresponding to each outlet port 30. The gauge ports 70 are depicted in the FIGS. 2 to 4 by G1 to G13 (in this embodiment there are 13 inlet ports 30 and 13 gauge ports 70).

In the embodiment of FIGS. 2 to 4, a manual switch, lever or knob 72 is connected to each gauge port 70. By manually operating the switch 72, the gauge port 70 is opened or closed. In use a technician can connect a hydraulic pressure gauge (not shown) to a desired gauge port 70 and then operate the corresponding manual switch 72 to permit fluid flow across the gauge port 70, to obtain a pressure measurement for a given outlet port 30.

Alternatively in the embodiment depicted in FIG. 1, the combination of the gauge port 70 and manual switch 72 is replaced with a double check valve 76, such as a quick connect ball valve coupler or other such valve. This negates the need for the manual operation of any switch, and removes the risk of a technician removing the pressure gauge while the gauge port 70 is open.

Because each isolated oil gallery 50 is in fluid communication with the corresponding supply port 30, an accurate indication of the pressure with the corresponding hydraulic device can be obtained.

Each second one way check valve 60 provides fluid communication with a common high pressure oil gallery 28. The high pressure oil gallery 28 is integral with or in direct fluid communication with line 26. Each of the second one way check valves 60 for each of the inlet ports 30 is connected to the common high pressure oil gallery 28. As such, the common high pressure oil gallery 28 will be under pressure if any one of the outlet ports 30 are pressurised.

A common first test port 80 is connected to the line 26 and hence the common high pressure oil gallery 28. The common test port 80 can be used to indicate to a technician if there is pressure in any one or more of the outlet ports 30. A second test port 82 may also be provided. The second test port 82 may be connected to a gauge mounted elsewhere in the system, such as in the driver's cabin or control room. This provides a constant indication that at least a portion of the system is under pressure, which may be useful. This may be in the form of a gauge, digital display, light or other such indicator.

In the event of a rapid depressurisation, i.e. if there is a fire, or alternatively during scheduled maintenance or repairs, the direction control valve 14 is switched from the position depicted in FIG. 1 to the second position, in which line 26 comes into fluid communication with line 18. The pressure in lines 18, 16 and the tank 15 is generally much lower than the pressure in the common high pressure oil gallery 28, so the hydraulic fluid rapidly bleeds back to the tank 15, and the isolator 10 is quickly depressurised.

The direction control valve 14 may have a manual dump handle 88 to bleed the isolator 10. The direction control valve 14 is generally a NC (normally closed) valve which opens when the handle 88 is depressed. The handle 88 may also have a lockout feature which allows the handle 88 to be locked in the open (bleed) position for maintenance on the hydraulic system and to prevent pressure build up in the hydraulic system.

The direction control valve 14 may alternatively or also be operable by an electrically controlled solenoid 90. The solenoid 90 may be wired into the fire detection and prevention system of a hydraulic machine, such that the direction control valve 14 is switched to the open, fluid bleed position in the event of a fire. The solenoid 90 may be controlled by the machines OEM or aftermarket fire system, or alternatively via the machines E-Stop circuit.

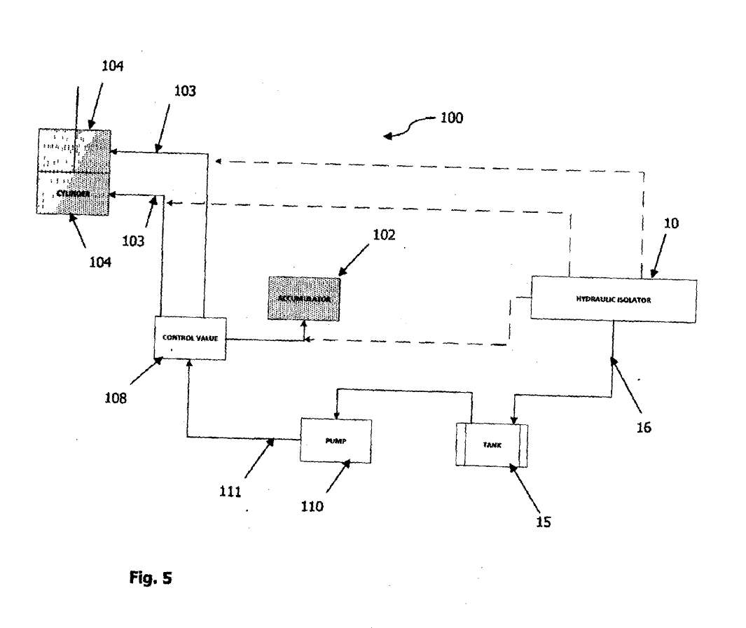

FIG. 5 depicts the hydraulic isolator 10 installed in a hydraulic system 100. The isolator 10 outlet ports 30 are in direct fluid communication with each of the hydraulic lines 103 connected to a hydraulic device 104 such as a cylinder of the system 100. One or more of the outlet ports 30 of the isolator 10 are also in fluid communication with the accumulator 102. As shown, each hydraulic device 104 is controlled by a control valve 108, which receives hydraulic fluid from a pump 110, which in turn is supplied by the tank 15. By opening the direction control valve 14, the hydraulic pressure in the pressurised side of the hydraulic system (between the pump 110 outlet 111 and the isolator 10) drops dramatically, until the pressure equalises within the system 100. Advantageously, even if the pump 110 and control valve 108 remain activated, the pressure in the hydraulic device 104 will not increase while the direction control bleed valve 14 remains open.

Advantageously, the isolator 10 enables a technician to test for stored pressure both and after the release of pressure either on a circuit by circuit basis, or from one central point.

Advantageously, the isolator 10 can be easily retrofitted to existing hydraulic machinery.

Advantageously, the circuits cannot be cross contaminated, and there is no possibility of a circuit being pressurised due to check valve design.

Although the invention has been described with reference to specific examples, it will be appreciated by those skilled in the art that the invention may be embodied in many other forms.

1. A fluid isolator comprising:
a primary outlet port adapted to be coupled to a hydraulic device;
a bleed valve having a first position and a second position;
a first line in fluid communication with the primary outlet port and the bleed valve;
a first one way valve located in the first line, the first one way valve inhibiting the flow of fluid toward the primary outlet port;
a second one way valve located in the first line, the second one way valve inhibiting the flow of fluid toward the primary outlet port;
a primary gauge port adapted to be coupled with a pressure gauge; and
a second line in fluid communication with the primary gauge port and a portion of the first line located between the first one way valve and the second one way valve;
wherein the bleed valve is switchable between the first position and the second position to permit the flow of fluid from the primary outlet port to a region of lower fluid pressure.

2. The fluid isolator of claim 1, further comprising one or more secondary outlet ports, each secondary outlet port being adapted to be coupled to an additional hydraulic device,
a third line extending between each secondary outlet port and the first line between the second one way valve and the bleed valve;
a third one way valve located in the third line, the third one way valve inhibiting the flow of fluid toward the secondary outlet port;
a fourth one way valve located in the third line, the fourth one way valve inhibiting the flow of fluid toward the secondary outlet port;
an secondary gauge port adapted to be coupled with a pressure gauge; and
a fourth line in fluid communication with the secondary gauge port and a portion of the third line located between the third one way valve and the fourth one way valve.

3. The fluid isolator of claim 1, wherein a first test port is located in the first line between the second one way valve and the bleed valve.

4. The fluid isolator of claim 3, wherein a second test port is located in the first line between the second one way valve and the bleed valve.

5. The fluid isolator of claim 2, wherein the primary and secondary gauge ports are double check valves.

6. The fluid isolator of claim 1, wherein the bleed valve is a direction control valve.

7. The fluid isolator of claim 6, wherein the bleed valve is a four port two position direction control valve.

8. The fluid isolator of claim 1, wherein the bleed valve is manually operable.

9. The fluid isolator of claim 1, wherein the bleed valve includes a solenoid and is electrically operable.

10. The fluid isolator of claim 2, further comprising a manual control to selectively provide fluid communication with the primary gauge port and the secondary gauge port.

11. The fluid isolator of claim 10, wherein the manual control is a button, knob or lever.

12. A hydraulic system comprising:
a fluid isolator according to claim 2;
a fluid reservoir in fluid communication with the bleed valve;
a pump in fluid communication with the fluid reservoir;
a control valve in fluid communication with the pump;
an accumulator in fluid communication with the control valve and one of the primary or secondary outlet ports of the fluid isolator;
a hydraulic device in fluid communication with the control valve; and
a line extending between one of said primary or secondary outlet ports of the fluid isolator and a line extending between the control valve and the hydraulic device.
